(19) United States
(12) Patent Application Publication
(10) Pub. No.: US 2006/0129617 A1
(43) Pub. Date: Jun. 15, 2006

(54) Method for controlling an information processing apparatus

(75) Inventors: Takaaki Nagai, Yokohama (JP); Aya Machida, Miura (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/285,658

(22) Filed: Nov. 21, 2005

(30) Foreign Application Priority Data
Nov. 22, 2004 (JP) 2004-337561

(51) Int. Cl. G06F 17/30

(52) U.S. Cl. 707/204

(57) ABSTRACT

A method for controlling an information processing apparatus configured to store a program code including a plurality of program modules and, every time an execution request for the program code is accepted that is transmitted from a user terminal communicatively connected therewith, sequentially execute each program module included in the program code to transmit an execution result for the execution request to the user terminal. The method comprises, when an update request for the program code is received from a management computer communicatively connected therewith, stopping acceptance of a new execution request for the program code transmitted from the user terminal and stopping the execution of the program module being currently executed, transmitting to the user terminal the information indicating that execution of a program module executed in response to the execution request for the program code is terminated, as the execution result for the execution request, based on information for identifying a program module to be updated included in the update request for the program code, updating the program module to be updated, and starting acceptance of an execution request for a new updated program code.

### CROSS-REFERENCE TO RELATED APPLICATIONS

The present application claims priority from Japanese Patent Application No. 2004-337561 filed on Nov. 22, 2004, which is herein incorporated by reference.

### BACKGROUND OF THE INVENTION

1. Field of the Invention

The present invention relates to a control method for an information processing apparatus, as well as to the information processing apparatus and a program.

2. Description of the Related Art

Recently, along with advancement of information technology, various information processing services can be received by forcing servers to execute application programs. For example, by sending a predetermined request via the Internet to a server operated by a bank, services such as a balance check can be received.

The application program in the server may be needed to be updated to a new application program for improving functionality and the like and, at the time of the update, the impact on the information processing service is desired to be minimized. Therefore, various technologies are developed for the case of updating the application program. See U.S. Pat. No. 5,920,725, for example.

By the way, an application program is constituted by including a plurality of program modules and an updated section may be only a portion of the program modules. However, even in such a case, the information processing service must be entirely suspended at the time of the update of the application program. Also, if the application program to be updated is being executed, the update operation must wait until the execution is terminated. In some types of the application program, it may take a few days to terminate the execution. Of course, during that period, new requests for the information processing service must not be allowed to be received.

### SUMMARY OF THE INVENTION

The present invention was conceived in consideration of the above, and it is therefore a major object of the present invention to provide a control method for an information processing apparatus, the information processing apparatus and a program which can reduce a suspension period of provision of information processing services at the time of update of application programs.

In order to solve the above and other problems, according to an aspect of the present invention there is provided a method for controlling an information processing apparatus configured to store a program code including a plurality of program modules and, every time an execution request for the program code is accepted that is transmitted from a user terminal communicatively connected therewith, sequentially execute each program module included in the program code to transmit an execution result for the execution request to the user terminal. The control method comprises, when an update request for the program code is received from a management computer communicatively connected therewith, stopping acceptance of a new execution request for the program code transmitted from the user terminal and stopping the execution of the program module being currently executed, transmitting to the user terminal the information indicating that execution of a program module executed in response to the execution request for the program code is terminated, as the execution result for the execution request, based on information for identifying a program module to be updated included in the update request for the program code, updating the program module to be updated, and starting acceptance of an execution request for a new updated program code.

The other problems disclosed by this application and solutions thereof will become more apparent from the following description of the implementations of the present invention and the accompanying drawings.

### BRIEF DESCRIPTION OF THE DRAWINGS

FIG. 1 is a diagram showing an overall configuration of an information processing system according to the implementation;

FIG. 2 is a diagram showing each configuration of a client, an application server and a management computer according to the implementation;

FIG. 3 is a diagram showing a memory of the client according to the implementation;

FIG. 4 is a diagram showing a memory of the application server according to the implementation;

FIG. 5 is a diagram showing a memory of the management computer according to the implementation;

FIG. 6 is a diagram showing how the application server and the management computer are communicatively connected over network according to the implementation;

FIG. 7 is a flowchart showing a process flow according to the implementation;

FIG. 8 is a flowchart showing a process flow according to the implementation;

FIGS. 9A, 9B is a diagram showing an AP thread management table according to the implementation;

FIG. 10 is a diagram for describing a sub-request according to the implementation;

FIG. 11 is a diagram for describing termination of execution of an application program according to the implementation;

FIG. 12 is a diagram showing how the application server and the management computer are communicatively connected over network according to the implementation;

FIG. 13 is a diagram showing an update list table according to the implementation;

FIG. 14 is a diagram showing a deployment information management table according to the implementation;

FIG. 15 is a flowchart showing a process flow according to the implementation;

FIG. 16 is a diagram showing how the application server and the management computer are communicatively connected over network according to the implementation; and

FIG. 17 is a diagram showing an execution information management table according to the implementation.

### DETAILED DESCRIPTION OF THE INVENTION

<<Example of Overall Configuration>>

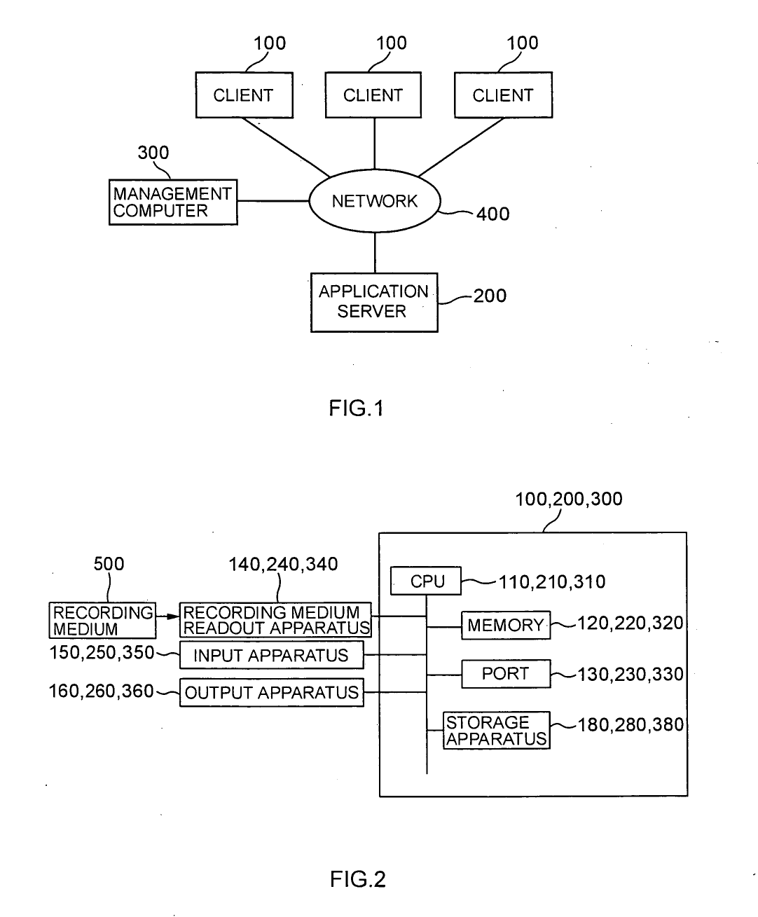

FIG. 1 shows an overall configuration of an information processing system according to an implementation of the present invention.

The information processing system according to the implementation is constituted by communicatively connecting clients (corresponding to a user terminal described in claims) 100, an application server (corresponding to an information processing apparatus described in claims) 200 and a management computer 300 through network 400.

The application server 200 is a computer for executing an application program depending on requests transmitted from the client 100 and for transmitting the execution result to the client 100. The application server 200 can be realized by a virtual machine or logic server, for example. The client 100 is a computer for transmitting execution requests of the application program to the application server 200 and for receiving the execution result from the application server 200. The client can be realized by a terminal. The management computer 300 is a computer for managingthe information system. For example, the management computer 300 updates the application program executed by the application server 200.

<Client>

As described above, the client 100 is a computer for receiving the execution result of the application program from the application server 200. For example, the client 100 can be a computer used by employees and others of a company and the like for performing business activities. In this case, for example, in order to manage daily work hours, each employee sends a clock-in time and clock-off time from the client 100 to the application server 200 executing a work-hour management program. Also, each employee receives a calculation result of the daily work hours or overtime hours. Alternatively, in such a case that a staff of a research and development department performs a strength check test of a prototype, the staff may send test condition data and the like from the client 100 to the application server 200 executing a strength analysis program and may receive a calculation result from the application server 200.

<Application Server>

The application server 200 is a computer for executing an application program. The application program can be various programs depending on the form of the information processing service provided by the application server 200, such as batch processing programs represented by a payroll accounting program or strength analysis program, or online real time processing programs represented by an online banking program or internet shopping program, for example. As described later in detail, the application program is constituted by including a plurality of program modules.

As a form of execution of the application program, all the program modules included in the application program may be stored in the application server 200 to be executed, or each program module may be distributed and stored into a plurality of application servers 200 to be executed. The information processing system is constituted by including at least one application server 200. The application server 200 receives various requests transmitted from the client 100, executes the application program and transmits an execution result corresponding to each request to the client 100.

<Management Computer>

The management computer 300 is a computer for managing the information processing system. The management computer 300 is used by various operators, such as a system administrator managing the information processing system and a program developer developing an application program. For example, if version upgrade is performed for several program modules constituting the application program, an operator updates the application program stored in the application server to a new application program using the management computer 300.

<Network>

The network 400 is communication network connecting the application server 200, the client 100 and the management computer in a manner enabling mutual communication. The network 400 can be LAN (Local Area Network). Also the network 400 can be WAN (Wide Area Network) such as the Internet, for example. The network 400 is constituted by including communication cables and various network equipments as components.

<<Equipment Configuration>>

Then, configuration of each of the application server 200, the management computer 300 and the client 100 is described.

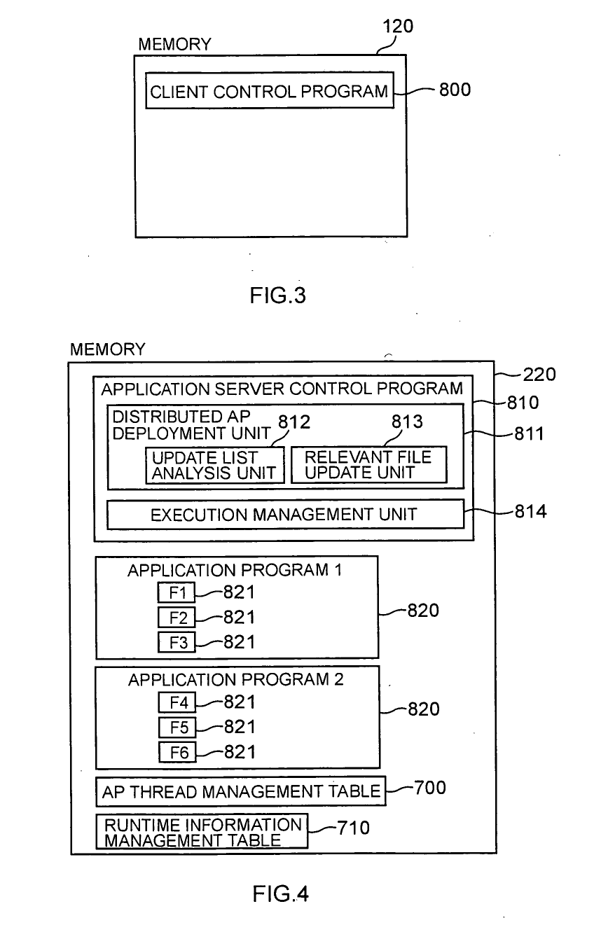

Each of the application server 200, the management computer 300 and the client 100 is a computer and has basically the same hardware configuration. Therefore, the hardware configurations of these components are collectively shown in FIG. 2 as one (1) block diagram. Also, FIG. 3 to FIG. 6 show control programs, tables and the like for realizing each function of these components.

<Configuration of Application Server>

The application server 200 is comprised of a CPU 210, a memory 220, a port 230, a recording medium readout apparatus 240, an input apparatus 250, an output apparatus 260 and a storage apparatus 280.

The CPU 210 is responsible for overall control of the application server 200 and realizes various functions of the application server 200 by executing an application server control program (corresponding to a program described in claims) 810 constituted by a code stored in the memory 220 for performing various operations according to the implementations and an application program (corresponding to a program code described in claims) 820. For example, by executing the application server control program 810 with the CPU 210 in cooperation with hardware equipments such as the memory 220, the port 230, the input apparatus 250, the output apparatus 260, the storage apparatus 280 and the like, a distributed AP deployment unit 811, an update list analysis unit 812, a relevant file update unit 813 and an execution management unit 814 are realized. The distributed AP deployment unit 811, the update list analysis unit 812, the relevant file update unit 813 and the execution management unit 814 realize a program code storage unit, an execution request acceptance unit, a program code execution unit, an update request reception unit, an execution request acceptance stop unit, a program code forced termination unit, an execution result transmission unit, a program code update unit, an execution request acceptance start unit and a runtime information storage unit described in claims. Details are described later.

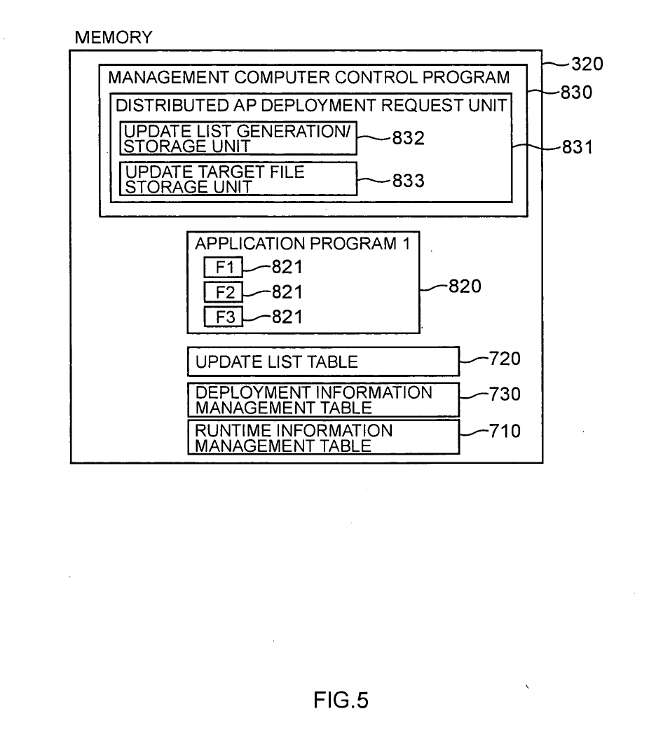

The memory 220 can be constituted by a semiconductor storage device, for example. FIG. 4 shows how the memory 220 is configured. As shown in FIG. 4, the memory according to the present invention stores the application server control program 810, the application program 820, an AP thread management table 700 and a runtime information management table 710.

The application server control program 810 is a program for controlling the application server 200. The application server control program 810 also performs control in the case of updating the application program 820. As described later in detail, the application program 820 is updated depending on an update request transmitted from the management computer 300. The application server control program 810 may also include a function for performing control as an operating system.

The application program 820 is a program for providing the information processing service to the client 100. In an example shown in FIG. 4, the memory 220 stores two (2) application programs 820, an application program 1 (820) and an application program 2 (820). Each of the application program 1 (820) and application program 2 (820) is a program for providing a separate information processing service. The application program 820 is constituted by including a plurality of program modules 821. If the application program 820 is written in, for example, a so-called procedural programming language, each program module 821 corresponds to a procedure. Also, for example, if the application program 820 is written in, for example, an object-oriented programming language, each program module 821 corresponds to a program code defining a class. In this case, at the time of execution of the application program 820, each program module 821 is managed as an instantiated object. The application program 820 may be a business program or program.

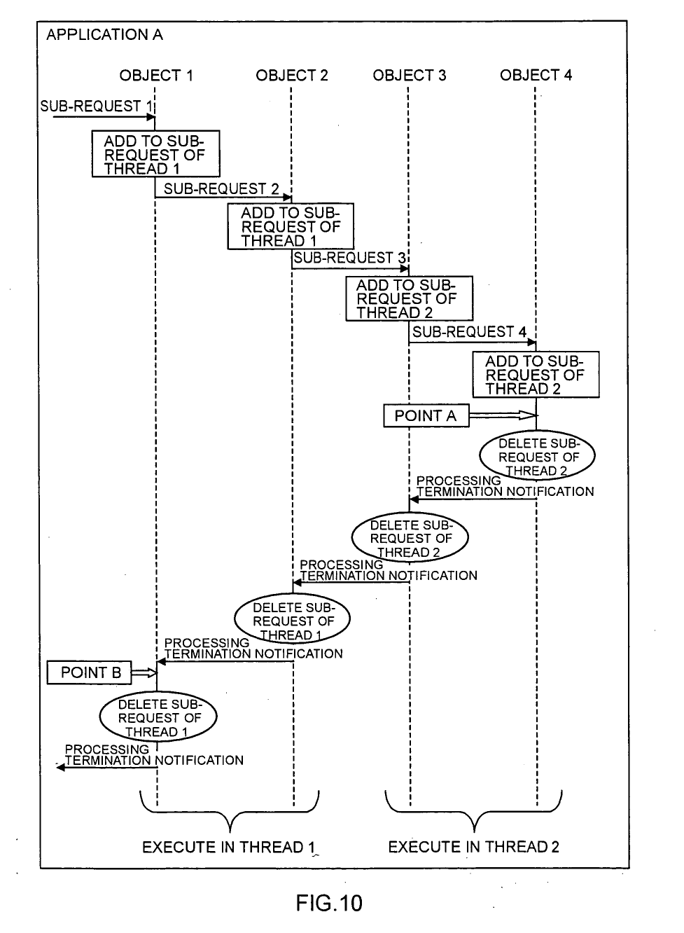

When accepting a request for provision of the information processing service (execution request for the application program) transmitted from the client 100, the application server 200 initiates execution of the application program 820 every time the request is accepted. The application server 200 manages the execution of the application program 820 for each request using a thread. The application server 200 executes the application program 820 by sequentially executing each program module 821, i.e., object in this case, included in the application program 820. For example, from an object executed first after the request is received from the client 100, the next object is called. Then, from the object, another object is further called. In this way, objects are executed sequentially. Each object called from another object returns a processing result to the calling object. Subsequently, the processing result is returned to the object executed first in response to the request from the client 100, and the application server 200 transmits the execution result of the application program 820 to the client 100. FIG. 10 shows how this occurs. In FIG. 10, an object 1 calls an object 2; the object 2 calls an object 3; and the object 3 calls an object 4. Then, a processing result of the object 4 is returned to the object 3; a processing result of the object 3 is returned to the object 2; and a processing result of the object 2 is returned to the object 1. The processing of each object for calling and executing another object is performed by transmitting a request to another object. This unit of request is referred to as a sub-request. If any abnormalities are detected during the execution of each object, the processing result returned to the calling object includes information indicating that the abnormality is detected. For example, if data requested by a sub-request do not exist in a database or if a divisor becomes zero when doing division, information indicating that condition is returned as the processing result.

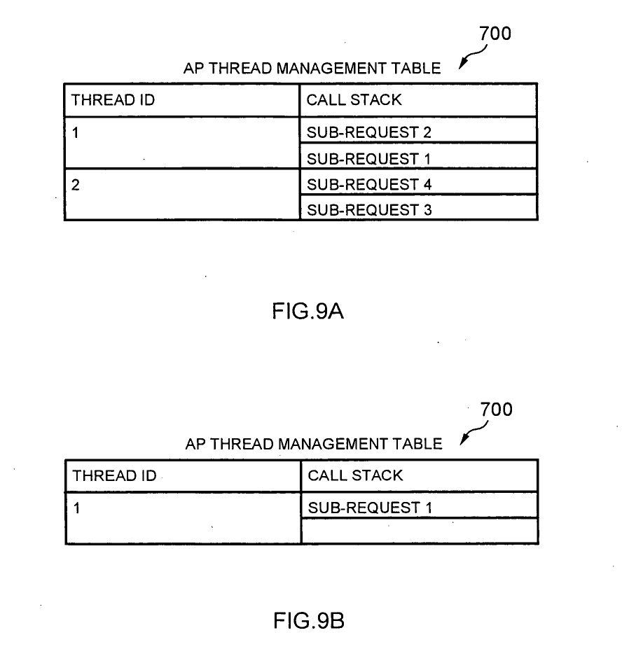

The AP thread management table 700 is a table for managing the state of the application program 820 being executed in response to each request transmitted from the client. As shown in FIG. 9A and FIG. 9B, the AP thread management table 700 is a table for storing a relationship between a thread corresponding to each request and a sub-request transmitted among respective objects started to be executed in response to the request. As the execution of the application program 820 proceeds, the AP thread management table 700 is updated every time an object is called or every time a processing result is returned from a called object. For example, the AP thread management table 700 shown in FIG. 9A is the table in the case that the application program 820 is executing the processing shown at “point A” of FIG. 10. The AP thread management table 700 shown in FIG. 9B is the table in the case that the application program 820 is executing the processing shown at “point A” of FIG. 10. In this way, by storing the state of the execution of the application program 820 into the AP thread management table 700, a currently executed object can be determined when the executed application program 820 is forcibly terminated, as described later.

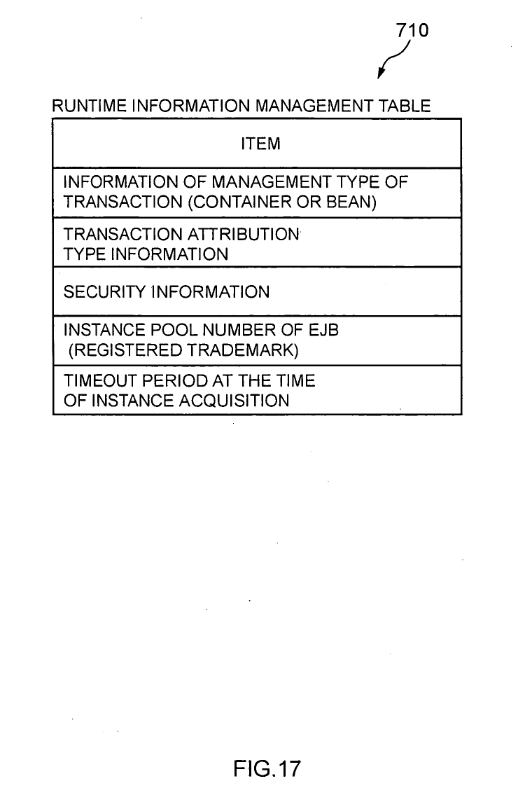

The runtime information management table 710 is a table for storing setup information describing a condition when the application program 820 is executed. For example, as shown in FIG. 17, the runtime information management table 710 lists a “management type of transaction”, “transaction attribution type”, “security”, “instance pool number of EJB (trademark or registered trademark of Sun Microsystems, Inc.)” and “timeout period at the time of instance acquisition”.

The “management type of transaction” lists information determining whether the initiation of the transaction is left to a container or is performed during processing of EJB (trademark or registered trademark of Sun Microsystems, Inc.). The “transaction attribution type” lists information determining whether the transaction is initiated or not when a method defined in EJB (trademark or registered trademark of Sun Microsystems, Inc.) is executed. This is information necessary if the initiation of the transaction is left to a container. The “security” lists information for limiting accounts which can execute the method of EJB (trademark or registered trademark of Sun Microsystems, Inc.). The “instance pool number of EJB (trademark or registered trademark of Sun Microsystems, Inc.)” lists information for defining a concurrent execution enabled number for EJB (trademark or registered trademark of Sun Microsystems, Inc.). The “timeout period at the time of instance acquisition” lists information for defining a waiting period when the execution is performed with a number greater than the maximum concurrent execution enabled number for EJB (trademark or registered trademark of Sun Microsystems, Inc.) at runtime.

The runtime information management table 710 is set by an operator when the application program 820 is prepared in the application server 200 in an executable manner.

Returning to FIG. 2, the recording medium readout apparatus 240 is an apparatus for reading a program or data stored in a recording medium 500. The read program and data are stored into the memory 220 or storage apparatus 280. Therefore, for example, the application server control program 810 and the application program 820 stored in the recording medium 500 can be read from the recording medium 500 and stored into the memory 220 or storage apparatus 280.

A flexible disk, a magnetic tape or a compact disk can be used as the recording medium 500. The recording medium readout apparatus 240 may be in the form of being built into the application server 200 or in the form of being attached externally.

The storage apparatus 280 can be a hard disk apparatus, semiconductor storage device or the like, for example. The storage apparatus 280 can also store the application server control program 810, the application program 820, the AP thread management table 700 and the runtime information management table 710. In this case, the CPU 210 reads the application server control program 810 and the application program 820 from the storage apparatus 280, which are stored into the memory 220 for execution.

The input apparatus 250 is an apparatus used for input data and the like into the application server 200 and acts as a user interface. For example, a keyboard or mouse can be used as the input apparatus 250.

The output apparatus 260 is an apparatus for outputting information to the outside and acts as a user interface. For example, a display or printer can be used as the output apparatus 260.

The port 230 is an apparatus for communicating. For example, the communication performed via the network 400 can be performed via the port 230 with other computers such as the management computer 300, the client 100 or the like. Also, for example, the application server control program 810 and the application program 820 can be received through the port 230 from other computer via the network 400 and stored into the memory 220 or storage apparatus 280.

<Configuration of Client>

Then, the configuration of the client 100 is described. The client 100 is comprised of a CPU 110, a memory 120, a port 130, a recording medium readout apparatus 140, an input apparatus 150, an output apparatus 160 and a storage apparatus 180. Each of these apparatus is the same as each apparatus provided in the application server 200 described above.

As shown in FIG. 3, the memory 120 provided in the client 100 stores a client control program 800. Various functions of the client 100 are realized by the CPU 110 executing the client control program 800.

The client control program 800 is a program for inputting/outputting or transmitting/receiving various data for employees and others performing business operations with the use of the application server 200. The client control program 800 can also include a function for performing control as an operating system. Also, the client control program 800 can be stored in the storage apparatus 180. In this case, the CPU 110 reads the client control program 800 from the storage apparatus 180, which is stored into the memory 120 for execution.

<<Configuration of Management Computer>>

Then, the configuration of the management computer 300 is described. The management computer 300 is comprised of a CPU 310, a memory 320, a port 330, a recording medium readout apparatus 340, an input apparatus 350, an output apparatus 360 and a storage apparatus 380. Each of these apparatus is the same as each apparatus provided in the application server 200 described above.

As shown in FIG. 5, the memory 320 provided in the management computer 300 stores a management computer control program 830, the application program 820, an update list table 720, a deployment information management table 730 and a runtime information management table 710. Various functions of the management computer 300 are realized by the CPU 110 executing the management computer control program 830. For example, by executing the management computer control program 830 with the CPU 310 in cooperation with hardware equipments such as the memory 320, the port 330, the input apparatus 350, the output apparatus 360, the storage apparatus 380 and the like, a distributed AP deployment request unit 831, an update list generation/storage unit 832 and an update target file storage unit 833 are realized. The distributed AP deployment request unit 831, the update list generation/storage unit 832 and the update target file storage unit 833 realizes an update history information storage unit and a deployment information storage unit described in claims.

The management computer control program 830 is a program for controlling the management computer 300. The management computer control program 830 performs various controls in the case of updating the application program 820 stored in the application server 200. For example, if some program modules 821 included in the application program 820 is improved, for each program module 821 included in the application program 820 currently stored in the application server 200, the update date and time are compared with the update date and time of each program module 821 included in the new application program 820 to execute the program modules 821 needed to be updated, for which update requests are transmitted to the application server 200. Also, the revision management can be performed for the application program 820. In this case, a comparison is performed between each program module 821 included in the application program 820 corresponding to the revision management number (identification number of a program code) input by an operator and each program module 821 included in the application program 820 currently stored in the application server 200 to execute the program modules 821 needed to be updated, for which update requests are transmitted to the application server 200.

In FIG. 5, the application program 820 stored in the memory 320 of the management computer 300 is a new application program 820 updated by a program developer. The management computer 300 transmits an update request for the application program 820 to the application server to execute the update to the new application program 820.

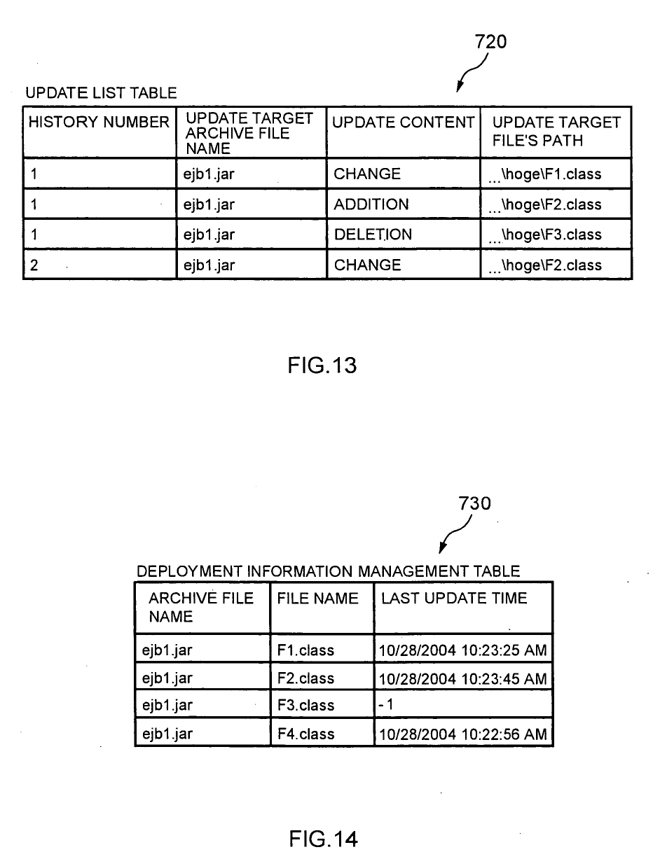

The update list table (corresponding to information for identifying a program module to be updated described in claims) 720 is information indicating which program module 821 should be updated by the application server 200. Also, the update list table 720 stores the identification number of the new application program 820 correspondingly to information for identifying each program module 821 constituting the new application program 820. When transmitting the update request to the application server 200, the management computer 300 transmits the update request along with the update list table 720. FIG. 13 shows an example of the update list table 720.

The update list table 720 is comprised of a “history number” field, an “update target archive file name” field, “update content” field and “update target file's path” field. The “history number” field lists the revision management number. The “update target archive file name” field lists a name of an archive file including the program module 821. The “update content” field lists the update content of the program module 821. For example, the content can be “deletion”, “addition” or “update”. The “update target file's path” field lists information indicating a storage location of the program code 821. When receiving the update list table 720, the application server 200 obtains the program code 821 included in the archive file listed in the “update target archive file name” field based on the content listed in the “update target file's path” field listing the storage location of the program code 821 and updates the program code 821 based on the update content listed in the “update content” field. In this way, each program module 821 constituting the new application program 820 can be identified based on the information listed in the “update target archive file name” field and “update target file's path” field. The storage location of the program code 821 listed in the “update target file's path” field can be the storage location in the storage apparatus 380 of the management computer 300. In this case, the application server receives the new program module 821 from the storage apparatus 380 of the management computer 300. Then, for example, if “update” is listed in the “update content” field, the update target program module 821 stored in the memory 220 of the application server 200 is cleared, and the new program module 821 transmitted from the management computer 300 is stored. If “deletion” is listed in the “update content” field, the update target program module 821 stored in the memory 220 of the application server 200 is cleared. Further, If “addition” is listed in the “update content” field, the new program module 821 transmitted from the management computer 300 is stored in the memory 220 of the application server 200.

The deployment information management table 730 is information for identifying each program module 821 included in the application program 820 currently stored in the application server 200.

The deployment information management table 730 is comprised of an “archive file name” field, a “file name” field and “last update time” field. The “file name” field lists a name of each program module 821 included in the application program 820 currently stored in the application server 200. The “archive file name” field lists a name of an archive file included in each program module 821. The “last update time” field lists information indicating the last update time of each program module 821.

If an operator operating the management computer 300 inputs into the management computer 300 an update request command for the application program 820 executed in the application server 200 along with the revision management number, the management computer 300 identifies the program module 821 needed to be updated in order to constitute the new application program 820 identified by the revision number, based on the information for identifying each program module 821 included in the application program 820 currently stored in the application server 200, which is listed in the deployment information management table 730, as well as the information for identifying each program module 821 constituting the application program 820 associated with the revision management number, which is stored in the update list table 720. Then, the management computer 300 transmits to the application server 200 the information for identifying each program module 821 identified as above along with an update request.

The runtime information management table 710 is a table for storing setup information describing a condition when the application program 820 is executed. The runtime information management table 710 stored in the application server 200 is a duplicate of the runtime information management table 710 stored in the management computer 300. When deploying a new application program 820 to the application server 200, an operator typically creates the runtime information management table 710 setting the runtime condition of the application program 820, which is bundled together with the application program 820 as an archive file to be transmitted to the application server 200. In this case, if only some program modules included in the application program 820 are updated, the application program 820 also including the program modules 821 not updated must be bundled with the runtime information management table 710 as an archive which is transmitted to the application server 200. However, as described above, in the implementation, if the application program 820 is updated, only the updated program modules 821 are transmitted to the application server 200. Also, if the content of the runtime information management table 710 is not changed, the runtime information management table 710 used before updating the application program 820 can be utilized without modification. In other words, if the application program 820 is updated to a new application program 820, the application server 200 can execute the new application program 820, utilizing the runtime information management table 710 referenced when the application program 820 before the update is executed. Therefore, in the implementation, an amount of time required to update the application program 820 can be reduced.

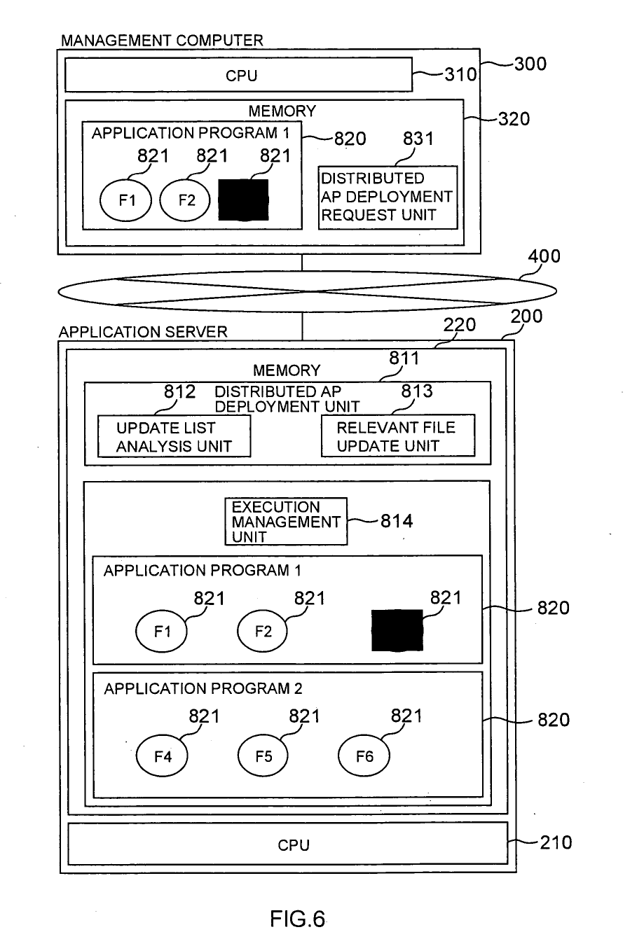

As above, each configuration of the application server 200, the management computer 300 and the client 100, and FIG. 6 shows how the management server 300 and the application server 200 are communicatively connected through the network 400.

<<Flow of Processing>>

<Update of Application Program>

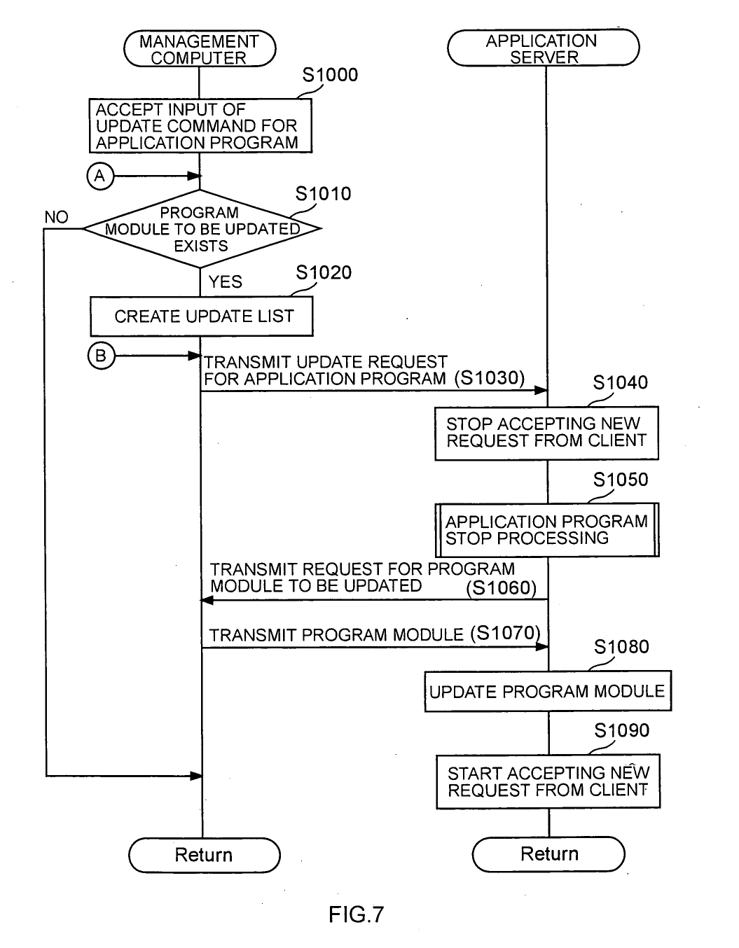

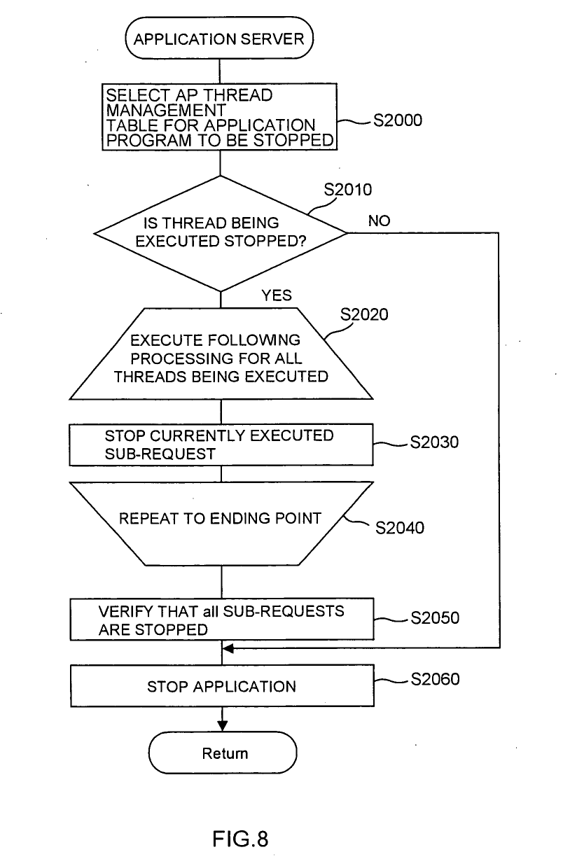

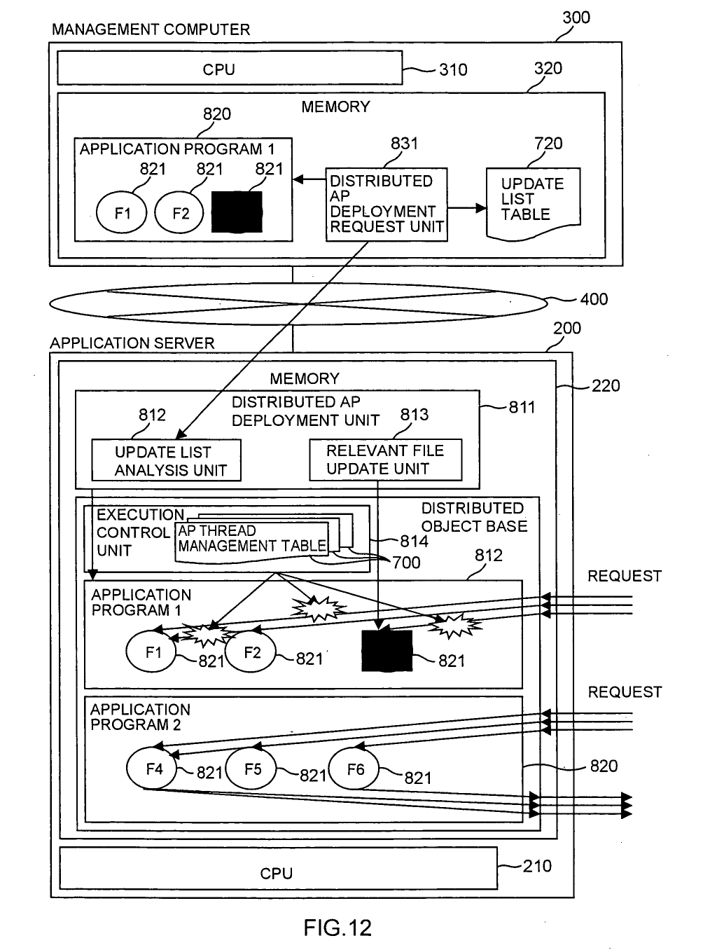

Then, a flow of processing is described for the case of updating the application program 820 stored in the application server 200 according to the implementation, with reference to FIG. 7, FIG. 8 and FIG. 12.

First, the distributed AP deployment request unit 831 of the management computer 300 accepts an update command of the application program 820 input from a user interface by an operator (S1000). Then, the distributed AP deployment request unit 831 of the management computer 300 determines whether the program module 821 to be updated exists or not (S1010). As described above, this determination can be performed by comparing the update date and time of each program module 821 included in the application program 820 stored in the memory 320 with the last update time of each program module 821 stored in the deployment information management table 730. As a result, if the program module 821 to be updated does not exist, the processing is ended. If the program module 821 to be updated exists, the distributed AP deployment request unit 831 of the management computer 300 creates the update list table 720 (S1020). Then, an update request for the application program 820 is transmitted to the application server 200 (S1030).

When receiving the update request for the application program 820, the execution management unit 814 of the application server 200 stops accepting a new request transmitted from the client 100 (S1040). The acceptance can be stopped by not receiving the new request, for example. Alternatively, the requests can be stored into a queue provided in the memory 220 of the application server 200. Then, the execution management unit 814 of the application server 200 performs the stop processing of the application program 820 (S1050).

FIG. 8 shows details of the stop processing of the application program 820.

First, the execution management unit 814 of the application server 200 refers to the AP thread management table 700 for the application program 820 to be stopped. Then, it is determined whether the application program 820 is currently executed or not (S2000). If the application program 820 is being executed, since the sub-request is transmitted between the objects for each thread generated in response to the request of the client 100, whether the application program 820 is currently executed or not can be determined by referring to the AP thread management table 700. As a result, if the currently executed thread exists (S2010), all the threads being executed are forced to stop the currently executed sub-requests (S2020 to S2040).

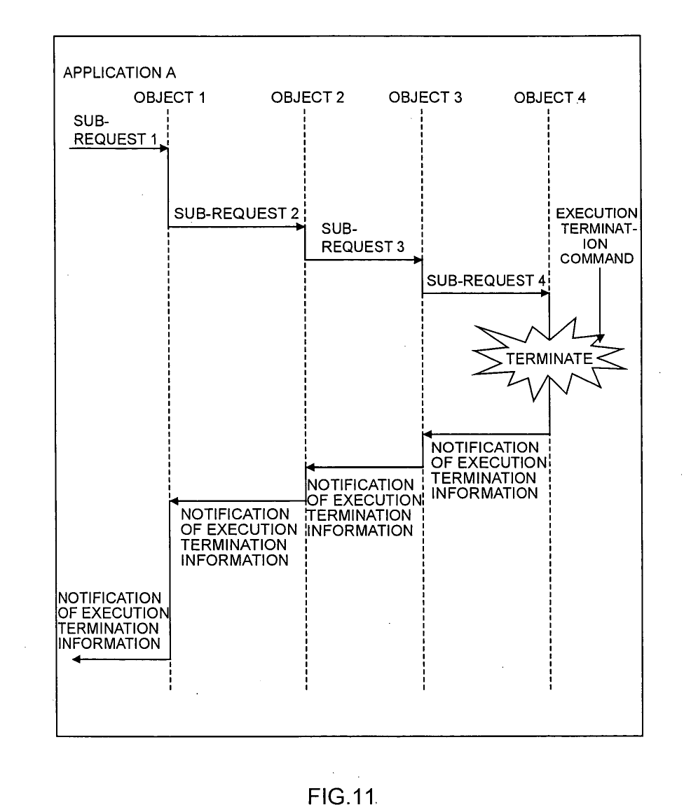

For example, the currently executed sub-request can be stopped as follows. For example, as shown in FIG. 11, if the object 4 is currently executed, the application server 200 forcibly terminates the processing of the object 4. The forced termination of the processing of the object 4 can be realized by interruption processing, for example. At this point, the execution management unit 814 of the application server 200 returns information indicating that some sort of abnormality is detected during execution of the object 4 to the object 3 calling the object 4 as a processing result. By doing this, also for the object 3, some sort of abnormality is detected during execution of the object 3. Subsequently, some sort of abnormality is sequentially detected through the object 1. Then, information indicating that some sort of abnormality is detected during execution is transmitted to the client 100 as an execution result. The information indicating that some sort of abnormality is detected during execution may be information indicating that the execution is canceled. In this way, since the client 100 can receives the execution result of the request transmitted to the application server 200, the processing can be completed. In the information processing system where enormous numbers of complicated logics are mutually intertwined to proceed with the processing, it is important to properly complete each piece of processing. Also, if the execution of the object is forcibly terminated as in the case of the implementation, it is extremely important to enable to properly transmit the execution result to the client for correctly and smoothly proceeding with the information processing in the client 100 and the application server 200.

When all the executed sub-requests are terminated, a call stack field of the AP thread management table 700 becomes empty. When verifying that all the sub-requests are stopped (S2050), the execution management unit 814 of the application server 200 performs the stop processing of the application program 820 (S2060).

When the application program 820 is stopped, the relevant file update unit 813 of the application server 200 requests to the management computer 300 the program modules 821 to be updated (S1060). When the program modules 821 to be updated are transmitted from the management computer 300 (S1070), only each of these program modules 821 is updated (S1080).

When the update is completed, the execution management unit 814 of the application server 200 starts accepting a new request from the client 100 (S1090). As described above, if the application program 820 is updated, the application server 200 according to the implementation can use the runtime information management table 710 used before updating the application program 820 without modification.

<Update of Application Program with Revision Specified>

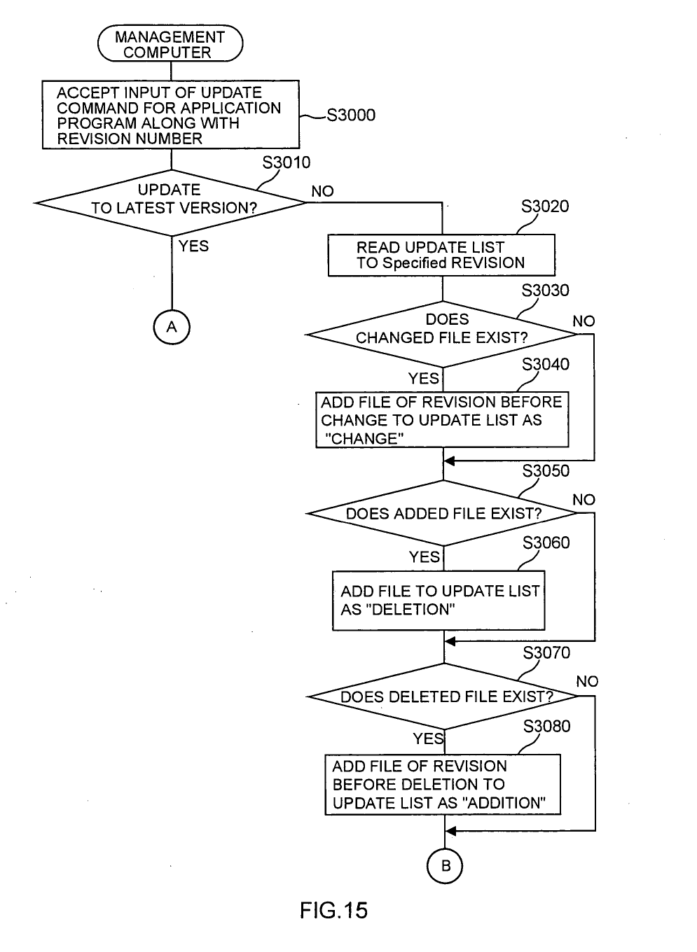

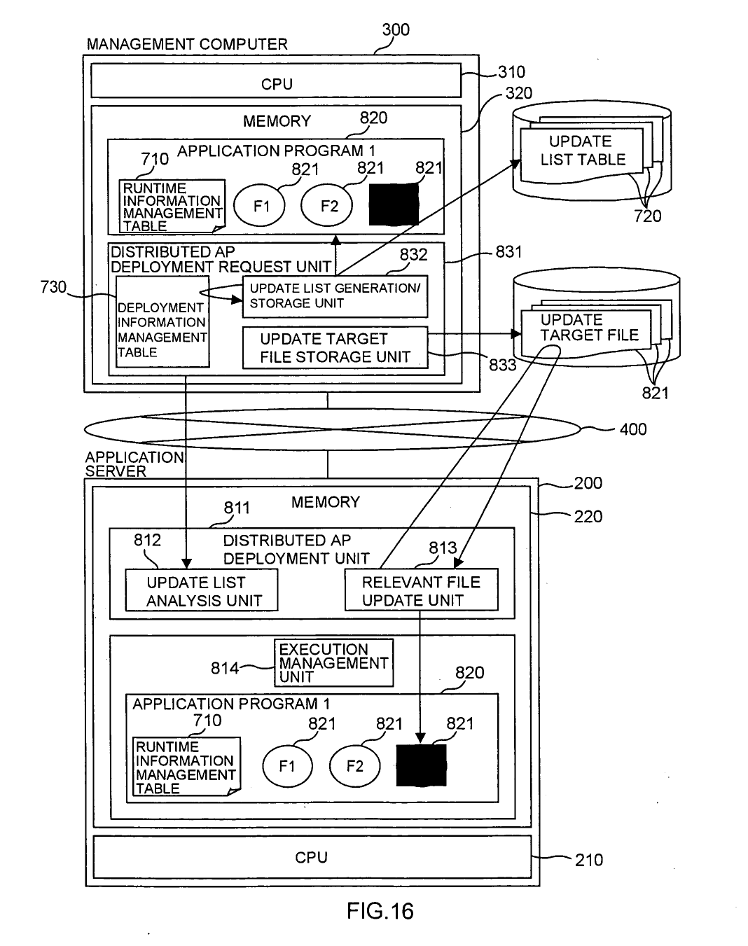

Then, a flow of processing is described for the case of updating the application program 820 stored in the application server 200 with the revision specified according to the implementation, with reference to FIG. 15 and FIG. 16.

First, the distributed AP deployment request unit 831 of the management computer 300 accepts an update command for the application program 820 input from a user interface by an operator along with the revision management number (S3000). Then, the distributed AP deployment request unit 831 of the management computer 300 determines whether the revision management number is the latest revision management number or not (S3010). If the revision management number is the latest revision management number, the processing after (A) of FIG. 7 is executed.

If the revision management number is not the latest revision management number, an update list to the specified revision is read (S3020). If the changed (updated) program module 821 is included in the update list (S3030), the program module 821 of the revision before the update is defined as “change” and is added to the update list table 720 (S3040). If the added program module 821 is included (S3050), the program module 821 of the revision before the update is defined as “deletion” and is added to the update list table 720 (S3060). If the deleted program module 821 is included (S3070), the program module 821 of the revision before the update is defined as “addition” and is added to the update list table 720 (S3080). With the above processing, the update list table 720 can list the update content of the program modules 821 necessary for updating to the application program 820 of the specified revision management number. Then, the processing after (B) of FIG. 7 is executed. In this way, for each program module 821 included in the application program 820 stored in the application server 200, the update to the program module 821 of the specified revision can be performed.

The update of the application program 820 according to the implementation has been described as above, and according to the implementation, the update operation of the application program 820 can be initiated even when the application program 820 is being executed. Therefore, contrary to the conventional case, the update operation can be initiated without need to wait for the execution of the application program 820 to be terminated. In this way, the system maintenance work can be systematically and immediately executed. This is extremely important in the information processing field where technologies rapidly advance. For example, in some cases, time-sensitive action must be taken to deal with a computer virus which is currently problematic worldwide or to correct defects intrinsic to the application program 820. In such a case, if the application program 820 cannot be updated for a few hours or days because the application program 820 is being executed, serious damage and loss may be incurred. According to the implementation, if the application program 820 is being executed, the processing is forcibly terminated and the execution result can be returned to the client 100 which has transmitted the request for starting the execution of the application program 820. In this way, while maintaining the normal information processing of both the application server 200 and the client 100, the update operation of the application program 820 can be immediately initiated.

Further, in the update of the application program 820 according to the implementation, for the setup information listing the condition when the application program 820 is executed, the setup information used before the update can be used after the update without modification. Further, the update of the application program 820 can be performed only for the program modules 821 needed to be updated. From these reasons, an amount of time of the update operation can be reduced and, since resetting processing is not needed for the setup information, the acceptance of the new request to the application program 820 can be quickly resumed after the update.

As described above, in the implementation, at the time of the update of the application program 820 executed in the application server 200, the impact on the information processing service can be minimized. This greatly contributes to improvement of the availability of the information processing system and enables to improve the quality and credibility of the information processing service offered to a user.

Each processing unit and each program according to the implementation can be realized by hardware, a program, an object, a thread and a process.

Although the best mode for carrying out the present invention has been described as above, the implementation is for the purpose of facilitating understanding of the present invention, rather than limiting the interpretation of the present invention. The present invention may be modified and altered without departing from the spirit thereof and the present invention includes equivalents thereof.

A control method for an information processing apparatus, the information processing apparatus and a program can thus be provided, which can reduce downtime of an information processing service.

While the illustrative and presently implementations of the present invention have been described in detail herein, it is to be understood that the inventive concepts may be otherwise variously embodied and employed and that the appended claims are intended to be construed to include such variations except insofar as limited by the prior art.

What is claimed is:

1. A method for controlling an information processing apparatus configured to store a program code including a plurality of program modules and, every time an execution request for the program code is accepted that is transmitted from a user terminal communicatively connected therewith, sequentially execute each program module included in the program code to transmit an execution result for the execution request to the user terminal, the method comprising:
when an update request for the program code is received from a management computer communicatively connected therewith,
stopping acceptance of a new execution request for the program code transmitted from the user terminal and stopping the execution of the program module being currently executed;
transmitting to the user terminal the information indicating that execution of a program module executed in response to the execution request for the program code is terminated, as the execution result for the execution request;
based on information for identifying a program module to be updated included in the update request for the program code, updating the program module to be updated; and
starting acceptance of an execution request for a new updated program code.

2. The method for controlling an information processing apparatus of claim 1,
wherein the information processing apparatus includes a runtime information storage unit storing setup information for listing conditions when the program code is executed, and
wherein, after the program code is updated to the new program code, the new program code is executed based on the setup information referenced when executing the program code before the update.

3. The method for controlling an information processing apparatus of claim 1,
wherein the management computer includes
an update history information storage unit storing the identification number of the new program code in relation to information for identifying each program module making up the new program code every time the update request for the program code is transmitted to the information processing apparatus; and
a deployment information storage unit storing information for identifying the each program module stored in the information processing apparatus,
wherein, when transmitting to the information processing apparatus the update request including the information for identifying the program module to be updated, a program module needed to be updated in order to constitute the new program code is identified based on the information for identifying the each program module stored in the deployment information storage unit and based on the information for identifying each program module making up the new program code related with the identification number of the new program code input from a user interface, and wherein the identified program module is identified as the program module to be updated.

4. The method for controlling an information processing apparatus of claim 1,
wherein the information for identifying a program module to be updated included in the update request for the program code is information for identifying a new program module to be added to the program code, and
wherein the information processing apparatus updates the program code to the new program code by storing the new program module transmitted from the management computer.

5. The method for controlling an information processing apparatus of claim 1,
wherein the information for identifying a program module to be updated included in the update request for the program code is information for identifying a program module to be deleted from the program code, and
wherein the information processing apparatus updates the program code to the new program code by clearing the program module to be deleted as stored.

6. The method for controlling an information processing apparatus of claim 1,
wherein the information processing apparatus updates the program code to the new program code by clearing the program module to be updated as stored and by storing the new program module transmitted from the management computer.

7. The method for controlling an information processing apparatus of claim 1,
wherein the program code is a program code written in an object-oriented programming language, and
wherein the each program module is a program code defining a class.

8. An information processing apparatus comprising:
a program code storage unit that stores a program code including a plurality of program modules;
an execution request acceptance unit that accepts an execution request for the program code transmitted from a user terminal communicatively connected therewith;
a program code execution unit that sequentially executes each program module included in the program code every time the execution request for the program code is accepted;
an update request reception unit that receives an update request for the program code from a management computer communicatively connected therewith;
an execution request acceptance cancellation unit that stops acceptance of a new execution request for the program code transmitted from the user terminal;
a program code forced termination unit that terminates execution of a program module being currently executed;
an execution result transmission unit that transmits to the user terminal the information indicating that execution of a program module executed in response to the execution request for the program code is terminated, as an execution result for the execution request;
a program code update unit that updates a program module to be updated included in the update request for the program code, based on information for identifying the program module to be updated; and
an execution request acceptance start unit that starts acceptance of an execution request for a new updated program code.

9. A program operable to cause an information processing apparatus storing a program code including a plurality of program modules to execute the steps of:
accepting an execution request for the program code transmitted from a user terminal communicatively connected therewith;
sequentially executing each program module included in the program code every time the execution request for the program code is accepted;
receiving an update request for the program code from a management computer communicatively connected therewith;
stopping acceptance of a new execution request for the program code transmitted from the user terminal;
terminating execution of a program module being currently executed;
transmitting to the user terminal the information indicating that execution of a program module executed in response to the execution request for the program code is terminated, as an execution result for the execution request;
updating a program module to be updated included in the update request for the program code, based on information for identifying the program module to be updated; and
starting acceptance of an execution request for a new updated program code.
